(19) United States
(12) Patent Application Publication
(10) Pub. No.: US 2023/0095317 A1
(43) Pub. Date: Mar. 30, 2023

(54) FLOOR TREATMENT APPLIANCE WITH A REPLACEABLE CHANGE COMPONENT AND SYSTEM CONSISTING OF A FLOOR TREATMENT APPLIANCE AND AN EXTERNAL TERMINAL

(71) Applicant: Vorwerk & Co. Interholding GmbH, Wuppertal (DE)

(72) Inventors: Simone RESKE, Waedenswil (CH); David ERKEK, Aarau (CH)

(73) Assignee: Vorwerk & Co. Interholding GmbH, Wuppertal (DE)

(21) Appl. No.: 17/945,160

(22) Filed: Sep. 15, 2022

(30) Foreign Application Priority Data
Sep. 27, 2021 (EP) 21199127.8

(51) Int. Cl. A47L 9/28; A47L 9/04; G06Q 30/06

(52) U.S. Cl. CPC A47L 9/2894; A47L 9/0477; A47L 9/2831; A47L 9/2826; A47L 9/0411; G06Q 30/0633

(57) ABSTRACT

A floor treatment appliance with a replaceable change component, a detection device for detecting an actual parameter that is influenced by wear of the change component, an evaluation device for determining a degree of wear of the change component based on the actual parameter and a communication device for communicating information concerning a required replacement of the change component to an external terminal that is communicatively linked to the floor treatment appliance. The change component is a floor treatment element that mechanically acts upon a floor surface to be treated, and the evaluation device calculates an average value of the actual parameter detected by the detection device referred to a defined time period of at least one hour, compares the average value with a defined reference value and determines the degree of wear of the change component in dependence on the result of the comparison.

### CROSS REFERENCE TO RELATED APPLICATIONS

Applicant claims priority under 35 U.S.C. § 119 of European Application No. 21199127.8 filed Sep. 27, 2021, the disclosure of which is incorporated by reference.

### BACKGROUND OF THE INVENTION

### 1. Field of the Invention

The invention pertains to a floor treatment appliance with a replaceable change component, a detection device for detecting an actual parameter that is influenced by wear of the change component, an evaluation device for determining a degree of wear of the change component based on the actual parameter and a communication device for communicating information concerning a required replacement of the change component to an external terminal that is communicatively linked to the floor treatment appliance.

In addition, the invention pertains to a system consisting of such a floor treatment appliance and an external terminal that is communicatively linked to the communication device of the floor treatment appliance.

### 2. Description of the Related Art

Floor treatment appliances and systems of the above-described type are known from the prior art. For example, the floor treatment appliance may be a floor conditioning appliance or a cleaning appliance, particularly a vacuum cleaning appliance or wiping appliance with a replaceable change component that is subjected to abrasion or wear during the use of the floor treatment appliance.

For example, DE 10 2016 109 015 A1 discloses a household appliance, namely a conventional household vacuum cleaner, which has a replaceable change component, for example, in the form of a filter module such as a filter bag or a motor protection filter. A sensor module monitors whether a current state parameter of the filter module exceeds a defined limiting value and respectively prompts a replacement of the filter or the transmission of corresponding information to the user. For example, the state parameter of the filter module may be a filtration performance or simply a period of operation of the filter module.

### SUMMARY OF THE INVENTION

Based on the above-described prior art, the invention aims to enhance floor treatment appliances of the above-described type in such a way that the user benefits from an optimal result of a floor treatment activity of the floor treatment appliance at all times.

In order to attain the above-defined objective, it is proposed that the change component comprises a floor treatment element for mechanically acting upon a floor surface to be treated, wherein the evaluation device is configured for calculating an average value of the actual parameter detected by the detection device referred to a defined time period of at least one hour, for comparing the average value with a defined reference value and for determining the degree of wear of the change component in dependence on the result of the comparison.

According to the invention, not only a state of a replaceable change component that does not mechanically interact with the surface to be treated, e.g. a filter in the interior of the floor treatment appliance, is determined, but also a degree of wear of a replaceable change component that mechanically acts upon the floor surface to be treated and therefore is subjected to wear due to material abrasion. The floor treatment element of the floor treatment appliance acts upon the floor surface to be treated by contacting the floor surface such that material of the change component is abraded until its degree of wear ultimately progresses to such a point that a replacement of the floor treatment element is required or at least recommended in the sense of an optimal floor treatment result. Since the mechanical wear of the change component has a negative effect on the success of the floor treatment, the wear is monitored by detecting an actual parameter. In the context of the invention, it was also recognized that not only the state of wear of the change component influences the mechanical action of the change component upon the floor surface to be treated, e.g. their engagement with one another, but that the type of floor surface being treated by the floor treatment appliance in fact also has an influence. For example, if the floor treatment element is a cleaning brush of the floor treatment appliance, the mechanical interaction of the floor treatment element with a carpeted floor is significantly greater than it would be the case, for example, on a hard floor surface. This increases the frictional resistance of the floor treatment element on the surface to be treated and an electric motor driving the rotating brush consumes more electrical energy on a carpeted floor than on a hard floor surface. When the floor treatment appliance on the other hand cleans a hard floor surface, the driving motor accordingly consumes less electrical energy, but this reduced energy consumption could be erroneously interpreted as a result of progressive wear of the change component. In order to draw no erroneous conclusion, but rather allow a correct determination of the degree of wear of the change component independently of the floor type, it was in the context of the invention recognized that it is necessary to exclude the influence of different floor types. According to the invention, this is achieved in that the evaluation device of the floor treatment appliance determines the detected actual parameter, which among other things is influenced by the wear of the change component, but also by the type of floor covering, over a defined time period, wherein the floor treatment appliance usually moves over different floor types within this time period such that different floor type-dependent actual parameters are determined by the detection device. The time period particularly is so long that a complete cleaning cycle of a household can be carried out and the floor treatment appliance therefore moves over all types of surfaces to be treated such as laminate, tiled floors, carpeted floors, wood floors and optionally other floor types. The average value of the measured actual parameter formed over this time period is then compared with a stored reference value. If the average value falls short of the reference value, for example, this is an indication of an excessive degree of wear of the change component such that the user should replace the change component in the near future, within a short time or also immediately.

As mentioned above, the floor treatment appliance is, for example, a user-operated or self-propelled floor conditioning appliance or a cleaning appliance such as a vacuum cleaner. The floor treatment appliance may comprise a base unit and different accessory devices that can be connected to the base unit. For example, the accessory devices may be devices that support the base unit on the surface to be cleaned. This may be, for example, a floor nozzle that is connected to the base unit and moved over the surface to be cleaned. Furthermore, an accessory device may also be a wiping plate, a polishing plate or the like. The floor treatment appliance has control electronics that also include the evaluation device. The control electronics of the floor treatment appliance control the parameters of the base unit, as well as the parameters of the accessory device, particularly the active components and component assemblies of the base unit and the connected accessory devices. Useful and/or required information for the user can be directly displayed on the floor treatment appliance in suitable form, e.g. by means of a display unit arranged on the base unit. Furthermore, information of this type can also be transmitted to an external terminal of the user such as a smartphone or a laptop by means of the communication device. Information in this sense may be status messages or operating data of the floor treatment appliance, e.g. filling levels of dust collection containers, adjustments of the floor treatment appliance, measured values of sensors, as well as corresponding data of an accessory device connected to the base unit. The detection device of the floor treatment appliance may either be installed in the base unit, in the accessory device or also in a component that is realized separately of the floor treatment appliance. The measured values of the detection device are transmitted to the external terminal of the user by means of a communication interface, e.g. the communication device of the floor treatment appliance. The evaluation of the measured values may either be carried out by an own evaluation device of the floor treatment appliance or by means of an external evaluation device. It is particularly also possible that a computing device of an external server or a computing device of the external terminal carries out the evaluation of the measuring data. Furthermore, the external terminal that is communicatively linked to the floor treatment appliance and receives the information on the required replacement of the change component may be a user terminal or a terminal such as a server of a manufacturer of the floor treatment appliance. It is furthermore possible that the external terminal is a server of a manufacturer or vendor of the change component, who is apprised of the fact that the new change component is required by this information.

It is furthermore proposed that the floor treatment element is a cleaning element, particularly a cleaning cloth or a cleaning brush, a floor conditioning element, particularly a polishing disk or a waxing disk, or an incorporation tool for incorporating a cleaning medium or a conditioning medium into the floor surface to be treated. Other types of floor treatment elements may also be provided. It is essential that these floor treatment elements actually act upon the floor surface to be treated mechanically, namely that they are in contact or in engagement therewith, while the floor treatment activity is carried out. The respective engagement or contact preferably takes place in such a way that an abrasion of the material of the floor treatment element occurs during the respective engagement or contact such that the dimensions of the floor treatment element are reduced in the course of time and the frictional force of the floor treatment element on the floor surface being treated therefore is also reduced. In addition to the actual floor treatment element, the change component may also comprise other elements or regions, e.g. housing sections, mountings for the floor treatment element, etc.

Furthermore, the floor treatment element may be driven by means of an electric motor or an actuator. Floor treatment elements of this type, which are driven relative to a housing of the floor treatment appliance, usually are subjected to even greater wear than stationary floor treatment elements. In this context, a movable floor treatment element may be, for example, a rotating cleaning roller, an oscillating wiping plate or the like. Such floor treatment elements usually are driven with the aid of electric motors. The drive may furthermore also comprise an actuator such as a bimetallic actuator, a piezo actuator, a shape memory actuator or the like.

The detection device may be configured for detecting a power consumption or a torque of an electric motor or actuator driving the floor treatment element. Furthermore, the detection device may also measure, for example, an induced voltage, a temperature rise, a sound emission, a magnetic field or another parameter depending on the type of floor treatment element or the type of drive device driving the floor treatment element.

The actual parameter detected by the detection device particularly may be an appliance parameter of the floor treatment appliance or a floor surface parameter of the floor surface being treated by the floor treatment element. The actual parameter, which indicates a measure for the degree of wear of the change component, therefore may be an own measured variable of the floor treatment appliance such as a power consumption, a torque or the like, but alternatively also a measured variable of the treated floor surface, which is influenced by the degree of wear of the change component. If the change component is no longer in optimal contact or engagement with the floor surface, this manifests itself in the treatment quality of the floor surface such that the floor surface itself accordingly provides an indication of the state of the change component.

The detection device particularly may be an optical measuring device that is configured for recording an image of the floor surface being treated by the floor treatment element or for detecting a reflection signal of the treated floor surface. In this case, the image of the floor surface preferably is an image of a completely treated floor surface. This image is compared with a reference image, e.g. one or more older pictures of the same section of the floor surface. Changes in the floor treatment state, e.g. cleaning state, of the floor surface or at least a defined surface section can be determined with the aid of an evaluation algorithm. It is particularly preferred that the reference image is a picture of a surface section that was treated with a new change component, i.e. a change component that was not yet subjected to wear. This subsequently defines the optimal state of the treated floor surface or surface section.

The time period, over which the average value of the actual parameter is formed, may amount to one day or several days, one week or several weeks or one month or several months. It is essential that the time period is so long that the floor treatment appliance is able to travel over different types of floor surfaces within this time period. It is particularly preferred that the time period corresponds to a complete floor treatment cycle of the floor treatment appliance within an apartment, a house, an office or the like. In this respect, it is also essential to distinguish time periods according to the invention from time periods that include an extremely brief average value formation for the sole purpose of signal smoothing or the exclusion of computational artifacts, respectively.

The detection device furthermore may be configured for detecting the actual parameter continuously or in defined time intervals during the time period, over which the average value of the actual parameter is formed. The time intervals may be defined regularly or irregularly. Depending on the length of the time period, it is advisable to either carry out a continuous data acquisition or analysis or merely a discrete data acquisition or data analysis.

In addition to the above-described floor treatment appliance, the invention furthermore proposes a system consisting of a floor treatment appliance and an external terminal that is communicatively linked to the communication device of the floor treatment appliance, wherein the external terminal comprises an application that is configured for informing a user of the floor treatment appliance of the determined degree of wear of the change component and for receiving from the user a specification with respect to the type of an automatic reaction of the evaluation device of the floor treatment appliance to be determined degree of wear and/or a specification with respect to a degree of wear, at which the automatic reaction should take place. According to this embodiment, the user himself can decide and specify to the system whether an automatic reaction or which automatic reaction to a determined degree of wear should take place. The use of the floor treatment appliance or its reaction is thereby flexibly adapted. The user is not incapacitated beyond a desired degree by automatic activities of the floor treatment appliance. In fact, the user can adjust the degree of a reaction or subsequent activity of the floor treatment appliance himself via the application installed on the external terminal. This particularly concerns the requirements for notifications of the floor treatment appliance to the user or limiting values of the degree of wear, which should lead to certain reactions of the floor treatment appliance or its evaluation device in the first place. The application particularly provides a configuration area, in which the user can make basic adjustments and adapt predefined values in accordance with his personal preferences, such that the behavior of the floor treatment appliance or the application corresponds to the request of the user, e.g. with respect to adjusted limiting values for initiating notifications or with respect to automatically reordering worn out change components.

The type of automatic reaction of the evaluation device to the determined degree of wear may ultimately include at least the following: automatically ordering a new change component from a merchandise management system and/or informing the user of the degree of wear. In this context, the degree of a reaction or subsequent action by the user can be preadjusted such that an individual bandwidth of pre-selectable actions, e.g. from automatically placing an order for a change component up to merely informing the user without additional activity automatisms, is realized.

In addition to the above-described properties of the system, it would furthermore be possible to carry out a registration of inventory levels of change components. In the course of an automatic order placement as a reaction of the floor treatment appliance to a critical degree of wear of the change component, a defined number of delivered change components can be registered in the application upon the respective dispatch or receipt of the new change component. For example, the application not only detects when a replacement of the change component is required, but also if this replacement was carried out. After the detected installation of the new change component, this information can be used for subtracting the change component removed from the warehouse from the inventory level registered in the application. Once the next-to-last change component has been removed from the inventory and only a single change component is available, the user can be notified of a required reorder or an order may be automatically placed. Furthermore, the user may also receive information concerning a telephone number, business address or the like for carrying out the reordering process. In addition, the application may optionally register all floor treatment appliances located in a household and store their type designations. The type designations and a corresponding database make it possible to determine the appropriate change components for the respective types. This is particularly interesting if different floor treatment appliances, which accordingly also contain different change components, are used in a household.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows an inventive system consisting of a floor treatment appliance and an external terminal;

FIG. 2 shows the external terminal while displaying a degree of wear of a change component; and

FIG. 3 shows the external terminal while displaying user-selectable adjustments.

### DETAILED DESCRIPTION OF PREFERRED EMBODIMENTS

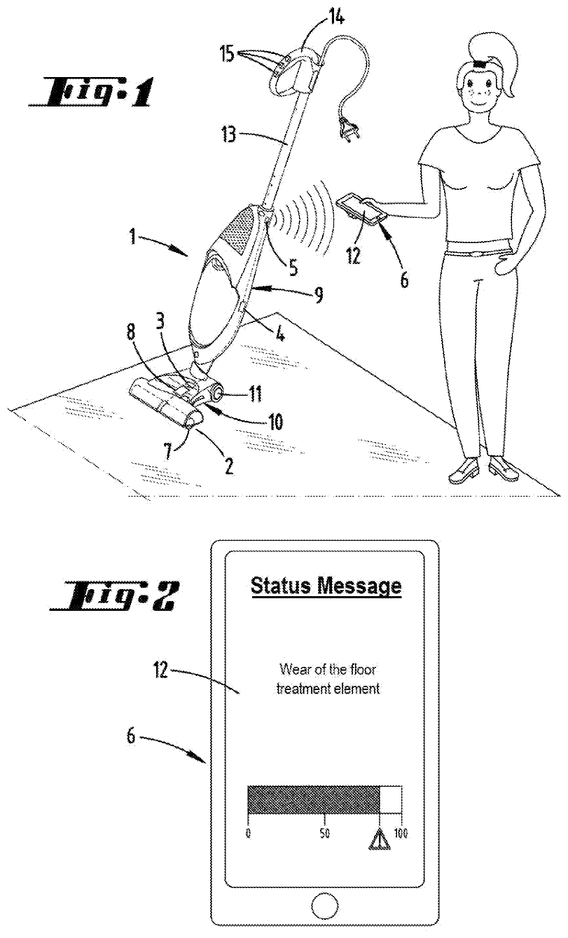

FIG. 1 shows an exemplary embodiment of an inventive floor treatment appliance 1. In this example, the floor treatment appliance 1 is realized in the form of a floor treatment appliance 1 that is manually operated by a user. In the context of the invention, however, a floor treatment appliance 1 may alternatively also be a self-propelled floor treatment appliance 1, particularly an autonomously traveling robot. In this example, the floor treatment appliance 1 is a conventional household vacuum cleaner that comprises a base unit 9 and an accessory device 10 that is separably connected to the base unit. The base unit 9 may—alternatively to the suction nozzle shown—also be connected to other types of accessory devices 10 depending on the desired application of the floor treatment appliance 1. The choice of the accessory device 10 makes it possible, for example, to convert the floor treatment appliance 1 from a mere vacuum cleaning appliance into a vacuuming-wiping appliance. This is realized, for example, by connecting an accessory device 10 in the form of a wiping plate to the base unit 9. The vacuuming function of the floor treatment appliance 1 can be preserved in this case. The base unit 9 has a shaft 13 on its side that faces away from the accessory device 10, wherein said shaft preferably is realized in a telescoping manner such that the user can adapt the length of the shaft 13 to his body size. A handle 14 with operating elements 15 is provided on the end of the shaft 13. The handle 14 enables the user to advantageously move the floor treatment appliance 1 over the floor surface to be treated during a floor treatment, particularly in the form of a conventional forward and backward motion.

The base unit 9 of the floor treatment appliance 1 furthermore has a communication device 5, e.g. a WLAN or Bluetooth interface, which is suitable for communicating with an external terminal 6 of a user. For example, the external terminal 6 may be a mobile terminal such as a mobile telephone, a laptop, a tablet computer or the like, but alternatively also a local desktop computer. The base unit 9 furthermore has an evaluation device 4 that particularly forms part of appliance electronics of the floor treatment appliance 1. The evaluation device 4 is configured for reading out one or more detection devices 3 of the base unit 9 and the accessory device 10 and for analyzing measuring data recorded by these detection devices. Furthermore, the evaluation device 4 may also act as a control unit and transmit control commands to one or more controllable components of the base unit 9 and the accessory device 10. In this context, the evaluation device 4 centrally controls all components, particularly electrical consumers, of the floor treatment appliance 1.

The exemplary accessory device 10 shown has a floor treatment element 7, which in this example is realized in the form of a rotatable cleaning brush that is driven by means of an electric motor 8. In the context of the invention, the floor treatment element 7 represents a change component 2 that is subjected to wear and therefore has to be replaced in good time in order to maintain the treatment success of the floor treatment appliance 1. Floor treatment elements 7 in the context of the invention are engaged with the floor surface to be treated, i.e. in mechanical contact with this floor surface, and therefore subjected to progressive abrasion of their material over time depending on an abrasive effect of the floor surface. The abrasive effect may concern, for example, an abrasion of the bristle filaments of a cleaning brush such that a free length of the bristle filaments is reduced in the course of the period of operation of the floor treatment element 7. As soon as the bristle filaments are shortened beyond a certain length, their cleaning effect on the floor surface to be treated is reduced to an ever lesser degree such that it is necessary to replace the worn out cleaning brush, i.e. change component 2, with an unused cleaning brush in order to restore the optimal cleaning capacity of the floor treatment appliance 1.

The evaluation device 4 is configured for determining a degree of wear of the change component 2 in order to determine a point in time, at which the change component 2 is optimally replaced. For this purpose, the evaluation device 4 initially evaluates the measuring data of one or more detection devices 3, wherein the measuring data concerns in this example an energy consumption of the electric motor 8 driving the floor treatment element 7. The current energy consumption of the electric motor 8 describes an actual parameter of the floor treatment appliance 1, which serves for determining the degree of wear of the change component 2. Other actual parameters of the floor treatment appliance 1 may alternatively also be detected. However, it is also possible to measure actual parameters of the floor surface itself, which provide an indication of the current treatment quality of the floor treatment appliance 1. In this case, the floor treatment appliance 1 may comprise a detection device 3, e.g., in the form of a camera that records an image of the currently finished floor surface. For example, the detection device 3 may also be a component that is realized separately of the floor treatment appliance 1.

In this case, the evaluation device 4 reads a physical parameter, which indicates a measure for the energy consumption or power consumption of the electric motor 8, out of the detection device 3. The evaluation device 4 collects the measuring data over a predefined time period of at least one hour and calculates an average value for the power consumed by the electric motor 8 during this time period from the collected measuring data. It is particularly preferred that the floor treatment appliance 1 is during this time period moved over different types of floor surfaces within a household, e.g. over a hard floor and also over a carpeted floor. Different types of floor surfaces cause different degrees of action upon the floor treatment element 7 and therefore also upon the electric motor 8 driving the floor treatment element 7. This in turn causes the power consumption to vary. The calculation of the average value takes place over the longest time period possible in order to exclude influences of the floor type on the determined actual parameter—and therefore on the degree of wear of the change component 2 calculated from the actual parameter. For example, this time period may amount to one or several hours, days, weeks or months.

The thusly formed average value of the measured actual parameter is compared with a defined reference value that particularly can be specified by the user himself. The degree of wear of the change component 2 is quantified in dependence on the result of the comparison between the average value and the reference value.

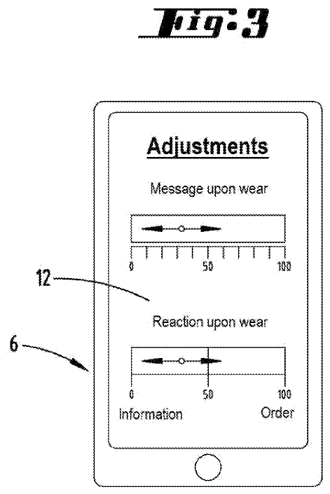

An application is installed on the external terminal 6 of the user, which is illustrated in greater detail in FIGS. 2 and 3, and enables the external terminal 6 to exchange data with the evaluation device 4. The external terminal 6 customarily has a wireless communication device—just like the floor treatment appliance 1—for data communication purposes. The user can make entries and, in particular, also adjustments on the floor treatment appliance 1 by means of a display unit 12 of the external terminal 6. According to the example illustrated in FIG. 3, the adjustments may be specifications for defining, for example, a certain degree of wear of the change component 2 as a “critical” degree of wear, at which the change component 2 should be replaced in order to ensure an optimal floor treatment result by means of the floor treatment appliance 1. Furthermore, the user can define a desired reaction of the floor treatment appliance 1 or its evaluation device 4 upon reaching the “critical” degree of wear. Two alternatives exist for the reaction in the present example, namely mere information on a required replacement of the change component 2 on the one hand and an initiation of an automatic ordering process from a merchandise management system, to which the evaluation device 4 of the floor treatment appliance 1 is communicatively linked, on the other hand.

The thusly made preadjustments define the degree of wear of the floor treatment element 7, which is displayed on the display unit 12 of the external terminal 6 as illustrated in FIG. 2. In this example, the user has made such a preadjustment that the evaluation device 4 should output a message to the user of the floor treatment appliance 1 upon determining a degree of wear of 80 percent of a maximally tolerable degree of wear of the change component 2. The user is accordingly informed of the fact that the critical degree of wear of the floor treatment element 7 has now been reached with a special message on the display unit 12 of the external terminal 6 illustrated in FIG. 2. It goes without saying that the status messages regarding the degree of wear may also be output in different ways, e.g. in the form of a different graphic representation, text, voice or sound.

Although only a few embodiments of the present invention have been shown and described, it is to be understood that many changes and modifications may be made thereunto without departing from the spirit and scope of the invention.

### LIST OF REFERENCE SYMBOLS

1 Floor treatment appliance
2 Change component
3 Detection device
4 Evaluation device
5 Communication device
6 External terminal
7 Floor treatment element
8 Electric motor
9 Base unit
10 Accessory device
11 Wheel
12 Display unit
13 Shaft
14 Handle
15 Operating element

What is claimed is:

1. A floor treatment appliance for treating a floor surface, comprising:
a replaceable change component in the form of a floor treatment element configured for mechanically acting upon the floor surface to be treated,
a detection device configured for detecting an actual parameter of the floor treatment appliance or the floor surface, which is influenced by wear of the floor treatment element,
a communication device configured for communicating with an external terminal that is communicatively linked to the floor treatment appliance, and
an evaluation device in the form of a processor configured for determining a degree of wear of the change component based on the actual parameter detected by means of the detection device,
wherein the evaluation device is configured for:
determining the degree of wear of the change component by calculating an average value of the actual parameter over a defined time period of at least one hour, by comparing the average value with a defined reference value and by determining the degree of wear of the change component in dependence on the result of the comparison, and for
initiating an automatic order of a new change component from a merchandise management system by means of the communication device as automatic reaction to the determined degree of wear.

2. The floor treatment appliance according to claim 1, wherein the actual parameter is selected from the following group: an appliance parameter of the floor treatment appliance, a power consumption of an electric motor or actuator driving the floor treatment element, a torque of an electric motor or actuator driving the floor treatment element, an induced voltage, a temperature rise, a sound emission, a magnetic field, a floor treatment state of the floor surface treated by the floor treatment element, a cleaning state of the floor surface treated by the floor treatment element and a degree of reflection of the floor surface treated by the floor treatment element.

3. The floor treatment appliance according to claim 1, wherein the evaluation device is configured for receiving a specification for a type of an automatic reaction of the evaluation device to the determined degree of wear or a specification for a value of the degree of wear, upon exceeding of which the automatic reaction should take place, and for taking into account said specification in carrying out the automatic reaction.

4. The floor treatment appliance according to claim 1, wherein the floor treatment element is selected from the group consisting of: a cleaning element, a cleaning cloth, a cleaning brush, a floor conditioning element, a polishing disk, a waxing disk and an incorporation tool for incorporating a cleaning medium or a conditioning medium into the floor surface to be treated.

5. The floor treatment appliance according to claim 1, wherein the time period taken into account for calculating the average value of the actual parameter amounts to one day, several days, one week, several weeks, one month, or several months.

6. The floor treatment appliance according to claim 1, wherein the floor treatment appliance comprises a memory, in which at least one reference value for the average value is stored, and wherein the evaluation device is configured for accessing the memory.

7. A floor treatment appliance comprising a replaceable change component, a detection device configured for detecting an actual parameter that is influenced by wear of the change component, an evaluation device configured for determining a degree of wear of the change component based on the actual parameter and a communication device configured for communicating information concerning a required replacement of the change component to an external terminal that is communicatively linked to the floor treatment appliance, wherein the change component comprises a floor treatment element configured for mechanically acting upon a floor surface to be treated, and wherein the evaluation device is configured for calculating an average value of the actual parameter detected by the detection device referred to a defined time period of at least one hour, for comparing the average value with a defined reference value and for determining the degree of wear of the change component in dependence on a result of the comparison.

8. The floor treatment appliance according to claim 7, wherein the floor treatment element is selected from the group consisting of: a cleaning element, a cleaning cloth, a cleaning brush, a floor conditioning element, a polishing disk, a waxing disk and an incorporation tool for incorporating a cleaning medium or a conditioning medium into the floor surface to be treated.

9. The floor treatment appliance according to claim 7, wherein the floor treatment element is driven by means of an electric motor or actuator.

10. The floor treatment appliance according to claim 7, wherein the detection device is configured for detecting a power consumption or a torque of an electric motor or actuator driving the floor treatment element.

11. The floor treatment appliance according to claim 7, wherein the actual parameter detected by the detection device is an appliance parameter of the floor treatment appliance or a floor surface parameter of the floor surface treated by the floor treatment element.

12. The floor treatment appliance according to claim 7, wherein the detection device is an optical measuring device that is configured for recording an image of the floor surface treated by the floor treatment element or for detecting a reflection signal of the treated floor surface.

13. The floor treatment appliance according to claim 7, wherein the time period, over which the average value of the actual parameter is formed, amounts to one day, several days, one week, several weeks, one month or several months.

14. The floor treatment appliance according to claim 7, wherein the detection device is configured for detecting the actual parameter continuously or in defined time intervals during the time period, over which the average value of the actual parameter is formed.

15. A system consisting of a floor treatment appliance according to claim 7 and an external terminal that is communicatively linked to the communication device of the floor treatment appliance, wherein the external terminal comprises an application that is configured for informing a user of the floor treatment appliance of the determined degree of wear of the change component and for receiving from the user a specification with respect to the type of an automatic reaction of the evaluation device of the floor treatment appliance to the determined degree of wear or a specification with respect to a degree of wear, at which the automatic reaction should take place.

16. The system according to claim 15, wherein the type of the automatic reaction of the evaluation device to the determined degree of wear includes at least one of the following: an automatic order of a new change component from a merchandise management system or the transmission of information on the degree of wear to the user.
